(19) United States
(12) Patent Application Publication
(10) Pub. No.: US 2003/0021418 A1
(43) Pub. Date: Jan. 30, 2003

(54) Cryptogram communication system

(76) Inventors: Kunio Arakawa, Tokyo (JP); Sunao Takatori, Tokyo (JP); Hisanori Kiyomatsu, Tokyo (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/148,730

(22) PCT Filed: Mar. 19, 2001
(86) PCT No.: PCT/JP01/02162

(51) Int. Cl. H04L 9/00

(52) U.S. Cl. 380/277

(57) ABSTRACT

First, a terminal device (1) transmits a connection request to a server device (2) (step S1). When receiving this connection request, the server device (2) selects a single piece of cipher key data (71) from a cipher key data set (62) corresponding to the terminal device 1 (step S2), and transmits a key identifier (72) of the selected cipher key data (71) to the terminal device (1) (step S3). When receiving the key identifier (72), the terminal device (1) reads a key identifier (52) identical with the key identifier (72) from key list data (21), enciphers the received key identifier (72) with cipher key data (51) corresponding thereto (step S4), and transmits it to the server device (2) (step S5). When receiving the enciphered key identifier (72), the server device (2) deciphers it (step S6), and compares the deciphered key identifier (72) and the key identifier (72) of the cipher key data selected before(step S7).

### TECHNICAL FIELD

The present invention relates to an enciphered communication system and an enciphered communication method for performing enciphered communication by a common key system, a server device and a terminal device used for the enciphered communication system and the enciphered communication method, and a key updating method applied to the enciphered communication system and the enciphered communication method.

### BACKGROUND ART

FIG. 7 is a block diagram showing the configuration of a conventional enciphered communication system disclosed in Japanese Patent Laid-open No. H07-327029, for example.

A transmitter 101 is a device for enciphering input data and transmitting the enciphered data.

In the transmitter 101, a data enciphering section 111 enciphers the input data based on a cipher key from a cipher key table 113.

Further, a cipher key number setting section 112 sets a number of a cipher key used for enciphering the input data. The cipher key table 113 previously stores a plurality of cipher keys and supplies a cipher key corresponding to a number from the cipher key number setting section 112 to the data enciphering section 111.

Furthermore, a cipher key number sending section 114 supplies the number of the cipher key set by the cipher key number setting section 112 to a multiplexing section 115. The multiplexing section 115 multiplexes the enciphered data from the data enciphering section 111 and the number of the cipher key from the cipher key number sending section 114, and transmits the multiplexed data.

A receiver 102 is a device for receiving and deciphering data transmitted from the transmitter 101.

In the receiver 102, a separating section 121 receives the multiplexed data transmitted from the transmitter 101 and separates this data into the enciphered data and the cipher key number.

Further, a cipher key number receiving section 123 supplies the cipher key number thus separated to a cipher key table 124. The cipher key table 124 is the same cipher key table as the cipher key table 113, and outputs a cipher key corresponding to the cipher key number from the cipher key number receiving section 123.

Furthermore, a data deciphering section 122 deciphers the enciphered data based on the cipher key from the cipher key table 124.

Next, operations of the respective devices in this conventional enciphered communication system will be explained.

When the cipher key number setting section 112 of the transmitter 101 sets a number of a cipher key, the number is supplied to the cipher key table 113 and the cipher key number sending section 114. Upon receipt of the number, the cipher key table 113 supplies a cipher key corresponding to the number to the data enciphering section 111. The data enciphering section 111 enciphers input data based on the cipher key, and supplies the enciphered data to the multiplexing section 115. Meanwhile, the cipher key number sending section 114 supplies the cipher key number to the multiplexing section 115.

The multiplexing section 115 of the transmitter 101 multiplexes the cipher key number into the enciphered data and transmits the multiplexed data via a predetermined transmission channel, for example, only when the cipher key is changed, when data communication is started, in a given cycle or in each frame.

The separating section 121 of the receiver 102 then receives the data from the transmitter 101 via the transmission channel, and if the received data includes a cipher key number, separates the cipher number and supplies it to the cipher key number receiving section 123 and supplies the other data (enciphered data) to the data deciphering section 122.

When the cipher key number receiving section 123 supplies the cipher key number to the cipher key table 124, a cipher key corresponding to the cipher key number is supplied from the cipher key table 124 to the data deciphering section 122. The data deciphering section 122 deciphers the enciphered data based on the cipher key, and outputs the deciphered data.

As described above, the transmitter 101 and the receiver 102 have the common cipher key tables 113 and 124, and a cipher key number which designates a cipher key is transmitted from the transmitter 101 to the receiver 102, whereby a cipher key used for enciphered communication on common key system is set or changed.

In the aforementioned conventional enciphered communication system, however, it is premised that a communication counterpart is authorized, and in order to authenticate the communication counterpart as an authorized one, additional information needs to be transmitted and received for the authentication, which requires storage circuits for previously storing such information and requires separate circuit and processing for authentication processing based on the information, whereby it is difficult to reduce the scale of the circuit for authentication processing when enciphered communication is performed on the common key system.

Further, in the conventional enciphered communication system, within the variety of cipher keys which are previously stored in the cipher key tables 113 and 124, the cipher key used in enciphered communication can be changed on both counterparts, but it is difficult to change a common cipher key stored in each of the cipher key tables 113 and 124 to a new cipher key.

Furthermore, in the conventional enciphered communication system, transmission of a cipher key to the communication counterpart is seldom performed for reasons of eavesdropping and the like, and it is necessary to provide common cipher key tables to the communication devices in the both counterparts, whereby it is difficult to reduce device costs and device sizes due to storage circuits for such cipher key tables. For example, in the case that one of the communication devices is small-sized like a mobile telephone, a necessary capacity increases due to such a storage circuit for the cipher key table.

It is an object of the present invention to obtain an enciphered communication system, an enciphered communication method, a server device, a terminal device, and a key updating method, capable of reducing a circuit scale while performing authentication processing in enciphered communication.

It is another object of the present invention to obtain an enciphered communication system and a key updating method, capable of changing a cipher key to a new one while ensuring the confidentiality of the common key.

It is still another object of the present invention to obtain an enciphered communication system, an enciphered communication method, a server device, and a terminal device, capable of easily sharing a cipher key while ensuring the confidentiality of the common key without storing plural pieces of cipher key data allocated to itself on the terminal device side.

### DISCLOSURE OF THE INVENTION

An enciphered communication system of the present invention comprises in a server device: a first storing means for storing plural pieces of cipher key data allocated to each terminal device in association with key identifiers inherent in respective pieces of cipher key data; a key selecting means for selecting any one of the plural pieces of cipher key data allocated to the terminal device which is a communication counterpart; a key identifier transmitting means for transmitting the key identifier of the cipher key data selected by the key selecting means to the terminal device; an enciphered key identifier receiving means for receiving the enciphered key identifier transmitted from the terminal device; a deciphering means for deciphering the enciphered key identifier received by the enciphered key identifier receiving means based on the cipher key data selected by the key selecting means; an authenticating means for comparing the key identifier deciphered by the deciphering means and the key identifier of the cipher key data selected by the key selecting means and authenticating the terminal device in accordance with a result of the comparison; and a first communicating means for performing enciphered communication based on the cipher key data selected by the key selecting means with the terminal device authenticated by the authenticating means, and comprises in the terminal device: a second storing means for storing plural pieces of cipher key data allocated to itself in association with key identifiers inherent in respective pieces of cipher key data; a key identifier receiving means for receiving the key identifier from the server device; a key reading means for reading cipher key data associated with the key identifier received by the key identifier receiving means from the second storing means; an enciphering means for enciphering the key identifier based on the cipher key data associated with the key identifier from the server device; an enciphered key identifier transmitting means for transmitting the key identifier enciphered by the enciphering means to the server device; and a second communicating means for performing enciphered communication with the server device based on the cipher key data read by the key reading means.

The use of this enciphered communication system makes it possible to perform authentication processing in enciphered communication through the use of cipher key data and key identifiers in the enciphered communication system and thereby reduce the scale of a circuit for authentication.

An enciphered communication method of the present invention comprises the steps of: selecting a single piece of cipher key data from plural pieces of cipher key data allocated to a terminal device as a communication counterpart, in a server device; transmitting a key identifier of the selected cipher key data from the server device to the terminal device; after reception of the key identifier by the terminal device, selecting cipher key data associated with the key identifier from plural pieces of cipher key data stored previously, in the terminal device; enciphering the key identifier based on the cipher key data associated with the key identifier from the server device, in the terminal device; transmitting the enciphered key identifier from the terminal device to the server device; deciphering the enciphered key identifier based on the cipher key data selected before, in the server device; comparing the deciphered key identifier and the key identifier of the cipher key data selected before and authenticating the terminal device in accordance with a result of the comparison; and performing enciphered communication between the server device and the authenticated terminal device by performing encipherment and/or decipherment with the selected cipher key data.

The use of this enciphered communication method makes it possible to perform authentication processing in enciphered communication through the use of cipher key data and key identifiers thereof in the enciphered communication system and thereby reduce the scale of a circuit for authentication.

A server device of the present invention comprises: a storing means for storing plural pieces of cipher key data allocated to each terminal device in association with key identifiers inherent in respective pieces of cipher key data; a key selecting means for selecting any one of the plural pieces of cipher key data allocated to the terminal device which is a communication counterpart; a key identifier transmitting means for transmitting the key identifier of the cipher key data selected by the key selecting means to the terminal device; an enciphered key identifier receiving means for receiving the enciphered key identifier transmitted from the terminal device; a deciphering means for deciphering the enciphered key identifier received by the enciphered key identifier receiving means based on the cipher key data selected by the key selecting means; an authenticating means for comparing the key identifier deciphered by the deciphering means and the key identifier of the cipher key data selected by the key selecting means and authenticating the terminal device in accordance with a result of the comparison; and a communicating means for performing enciphered communication based on the cipher key data selected by the key selecting means with the terminal device authenticated by the authenticating means.

The use of this server device makes it possible to perform authentication processing in enciphered communication through the use of cipher key data and key identifiers thereof in an enciphered communication system and thereby reduce the scale of a circuit for authentication.

A terminal device of the present invention comprises: a storing means for storing plural pieces of cipher key data allocated to itself in association with key identifiers inherent in respective pieces of cipher key data; a key identifier receiving means for receiving the key identifier from the server device; a key reading means for reading the cipher key data associated with the key identifier received by the key identifier receiving means from the storing means; an enciphering means for enciphering the key identifier based on the cipher key data associated with the key identifier from the server device; an enciphered key identifier transmitting means for transmitting the key identifier enciphered by the enciphering means to the server device; and a communicating means for performing enciphered communication with the server device based on the cipher key data read by the key reading means.

The use of this terminal device makes it possible to perform authentication processing in enciphered communication through the use of cipher key data and key identifiers thereof in a enciphered communication system and thereby reduce the scale of a circuit for authentication.

An enciphered communication system of the present invention comprises in the server device: a first storing means for storing plural pieces of cipher key data in association with key identifiers inherent in respective pieces of cipher key data; an enciphering means for enciphering new cipher key data; a first transmitting means for transmitting a key identifier of cipher key data used for enciphering the new cipher key data to the terminal device; a second transmitting means for transmitting the new cipher key data enciphered by the enciphering means to the terminal device; and a first updating means for updating the cipher key data stored in the first storing means with the new cipher key data, and comprises in the terminal device: a second storing means for storing plural pieces of cipher key data allocated to itself in association with key identifiers inherent in respective pieces of cipher key data; a first receiving means for receiving the key identifier of the cipher key data used for enciphering the new cipher key data from the server device; a second receiving means for receiving the enciphered new cipher key data from the server device; a key reading means for reading from the second storing means cipher key data being associated with the key identifier received by the first receiving means; a deciphering means for deciphering the enciphered new cipher key data received by the second receiving means based on the cipher key data read by the key reading means; and a second updating means for updating the cipher key data stored in the second storing means with the new cipher key data deciphered by the deciphering means.

The use of this enciphered communication system makes it possible to change a cipher key common to both the terminal device and the server device to a new one while ensuring the confidentiality of a common key.

Moreover, in addition to the enciphered communication system of the aforementioned invention, in an enciphered communication system of the present invention, the enciphering means of the server device enciphers the new cipher key data and an identifier for confirming completion of update, the first transmitting means or the second transmitting means of the server device transmits the enciphered identifier for confirming the completion of update to the terminal device, the first receiving means or the second receiving means of the terminal device receives the enciphered new cipher key data and the enciphered identifier for confirming the completion of update from the server device, and the deciphering means of the terminal device deciphers the enciphered new cipher key data and the enciphered identifier for confirming the completion of update. Besides, the enciphered communication system of the present invention further comprises in the terminal device: an enciphering means for enciphering the identifier for confirming the completion of update deciphered by the deciphering means when the update of the cipher key data by the second updating means is completed; and an update completion identifier transmitting means for transmitting the identifier for confirming the completion of update enciphered by the enciphering means to the server device, and further comprises in the server device: an update completion identifier receiving means for receiving the enciphered identifier for confirming the completion of update from the terminal device; a deciphering means for deciphering the enciphered identifier for confirming the completion of update; and an update completion confirming means for determining whether or not the update of the cipher key with the new cipher key data has been completed by comparing the identifier for confirming the completion of update deciphered by the deciphering means and the original identifier for confirming the completion of update.

If this enciphered communication system is used, it is difficult to forge the enciphered identifier for confirming the completion of update, and hence spoofing by a false terminal device becomes difficult, whereby the server device can surely confirm the completion of update of a cipher key in the terminal device.

An enciphered communication system of the present invention is designed so that, in addition to the enciphered communication system of the aforementioned invention, the first transmitting means or the second transmitting means of the server device transmits a key identifier for reply which designates cipher key data used when the identifier for confirming the completion of update is enciphered in the terminal device, the first receiving means or the second receiving means of the terminal device receives the key identifier for reply, the enciphering means of the terminal device enciphers the identifier for confirming the completion of update deciphered by the deciphering means based on cipher key data associated with the key identifier for reply, and the deciphering means of the server device deciphers the enciphered identifier for confirming the completion of update received by the update completion identifier receiving means based on the key identifier for reply.

If this enciphered communication system is used, the cipher key data for the identifier for confirming the completion of update is designated by the server device, and hence the cipher key data for the identifier for confirming the completion of update can be changed properly, whereby it becomes more difficult to forge the enciphered identifier for confirming the completion of update.

Moreover, an enciphered communication system of the present invention is designed so that, in addition to the enciphered communication systems of the aforementioned respective inventions, the enciphering means of the server device selects, as cipher key data for enciphering the new cipher key data, the cipher key data having a bit length longer than the cipher key data used in the enciphered communication as cipher key data for enciphering the new cipher key data.

The use of this enciphered communication system makes it possible to safely transmit cipher key data which requires higher confidentiality than ordinary communication data to the terminal device.

Furthermore, an enciphered communication system of the present invention is designed so that, in addition to the enciphered communication systems of the aforementioned respective inventions, the first transmitting means and the second transmitting means respectively transmit data to the first receiving means and the second receiving means via different channels in a spread spectrum system transmission path.

If this enciphered communication system is used, in order to acquire cipher key data for updating by eavesdropping, it is required to eavesdrop two channels in a spread spectrum system which have high confidentiality and to break a cipher, and hence it becomes more difficult to look surreptitiously at the cipher key data to be updated.

A key updating method of the present invention comprises the steps of: updating cipher key data stored previously with new cipher key data in a server device; enciphering the new cipher key data in the server device; transmitting the enciphered new cipher key data from the server device to a terminal device; transmitting a key identifier of cipher key data used for enciphering the new cipher key data from the server device to the terminal device; after reception of the key identifier of the cipher key data used for enciphering the new cipher key data from the server device, selecting cipher key data associated with the received key identifier out of plural pieces of cipher key data allocated to the terminal device, in the terminal device; after reception of the enciphered new cipher key data from the server device, deciphering the enciphered new cipher key data based on the cipher key data selected by the received key identifier, in the terminal device; and updating the cipher key data in the terminal device with the deciphered cipher key data.

The use of this key updating method makes it possible to change a cipher key common to both the terminal device and the server device to a new one while ensuring the confidentiality of the common key.

An enciphered communication system of the present invention comprises in a server device: a first communicating means for performing enciphered communication with a terminal device via a first channel in a spread spectrum system transmission path; and a cipher key transmitting means for transmitting cipher key data used for the first channel to the terminal device via a second channel different from the first channel in the spread spectrum system transmission path, and comprises in the terminal device: a cipher key receiving means for receiving the cipher key data transmitted from the terminal device via the second channel; and a second communicating means for performing enciphered communication with the server device via the first channel based on the cipher key data received by the cipher key receiving means.

If this enciphered communication system is used, in order to eavesdrop enciphered communication, it is required to eavesdrop cipher key data used in the enciphered communication and eventually eavesdrop two channels in a spread spectrum system which have high confidentiality, and hence it becomes more difficult to eavesdrop enciphered communication.

Besides, in the terminal device, a storing means for storing plural pieces of cipher key data allocated to the terminal device becomes unnecessary, which enables a reduced device cost and a reduced device size.

Moreover, an enciphered communication system of the present invention is designed so that, in addition to the enciphered system of the aforementioned invention, the server device further comprises a first key changing means for changing cipher key data used for the first channel, the cipher key data transmitting means of the server device transmits new cipher key data to be changed by the first key changing means to the terminal device, the terminal device further comprises a second key changing means for changing the cipher key data used for the first channel, and that when the new cipher key data is received by the cipher key receiving means of the terminal device, the second key changing means changes the cipher key data to perform encipherment and decipherment with respect to the first channel to the received cipher key data.

If this enciphered communication system is used, cipher key data is changed, for example, in each session, and hence eavesdropping of enciphered communication becomes more difficult.

Further, an enciphered communication system of the present invention is designed so that, in addition to the enciphered communication system of the aforementioned invention, the server device, during a session with the terminal device via the first channel, transmits the new cipher key data used in the session to the terminal device via the second channel.

If this enciphered communication system is used, eavesdropping of enciphered communication becomes still more difficult.

Furthermore, an enciphered communication system of the present invention is designed so that, in addition to the aforementioned respective enciphered communication systems, the server device further comprises an enciphering means for enciphering the new cipher key data based on cipher key data being used currently, the cipher key transmitting means of the server device transmits the new cipher key data enciphered by the enciphering means to the terminal device via the second channel, and the terminal device further comprises a deciphering means for deciphering the enciphered new cipher key data, the cipher key receiving means of the terminal device receives the enciphered new cipher key data via the second channel, the deciphering means of the terminal device deciphers the received enciphered new cipher key data, and that the second key updating means of the terminal device changes the cipher key data used for the first channel to the deciphered new cipher key data.

If this enciphered communication system is used, the new cipher key data is transmitted while being enciphered, whereby eavesdropping enciphered communication becomes much more difficult.

An enciphered communication method of the present invention comprises the steps of: performing enciphered communication between a server device and a terminal device via a first channel in a spread spectrum system transmission path; and transmitting cipher key data used for the first channel from the server device to the terminal device via a second channel different from the first channel in the spread spectrum system transmission path.

If this enciphered communication system is used, in order to eavesdrop enciphered communication, it is required to eavesdrop cipher key data used in the enciphered communication and eventually eavesdrop two channels in a spread spectrum system which have high confidentiality, and hence it becomes more difficult to eavesdrop enciphered communication.

Besides, in the terminal device, a storing means for storing plural pieces of cipher key data allocated to the terminal device becomes unnecessary, which enables a reduced device cost and a reduced device size.

A server device of the present invention comprises: a communicating means for performing enciphered communication with a terminal device via a first channel in a spread spectrum system transmission path; and a cipher key transmitting means for transmitting cipher key data used for the first channel via a second channel different from the first channel in the spread spectrum system transmission path.

If this server device is used, in order to eavesdrop enciphered communication, it is required to eavesdrop cipher key data used in the enciphered communication and eventually eavesdrop two channels in a spread spectrum system which have high confidentiality, and hence it becomes more difficult to eavesdrop enciphered communication.

A terminal device of the present invention comprises: a cipher key receiving means for receiving cipher key data transmitted from the terminal device via a first channel in a spread spectrum system transmission path; and a communicating means for performing enciphered communication with a server device via a second channel in the spread spectrum system transmission path.

If this terminal device is used, in order to eavesdrop enciphered communication, it is required to eavesdrop cipher key data used in the enciphered communication and eventually eavesdrop two channels in a spread spectrum system which have high confidentiality, and hence it becomes more difficult to eavesdrop enciphered communication.

Besides, a storing means for storing plural pieces of cipher key data allocated to the terminal device becomes unnecessary, which enables a reduced device cost and a reduced device size.

### BRIEF DESCRIPTION OF THE DRAWINGS

FIG. 1 is a block diagram showing the configuration of an enciphered communication system according to the embodiment 1 of the present invention;

FIG. 2 is a block diagram showing the details of key list data in a terminal device in FIG. 1;

FIG. 3 is a block diagram showing the details of terminal device list data and key list data in a server device in FIG. 1;

FIG. 4 is a sequence diagram explaining an enciphered communication method in the enciphered communication system according to the embodiment 1;

FIG. 5 is a sequence diagram explaining operations of respective devices in key update in an enciphered communication system according to the embodiment 2;

FIG. 6 is a block diagram showing the configuration of an enciphered communication system according to the embodiment 3 of the present invention; and

FIG. 7 is a block diagram showing a configuration of a conventional enciphered communication system.

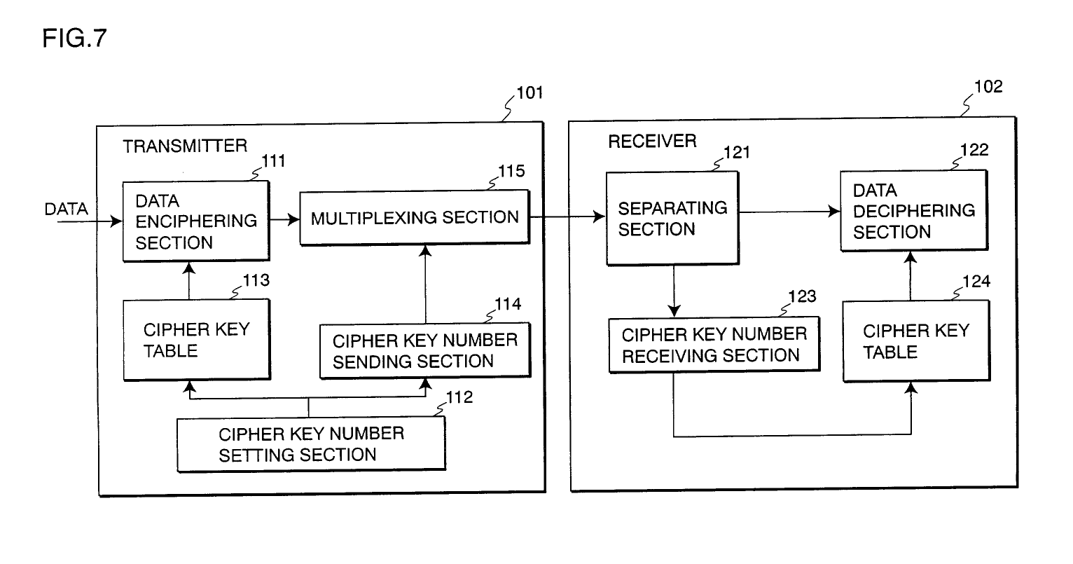

### BEST MODE FOR CARRYING OUT THE INVENTION

Embodiments of the present invention will be explained below based on the drawings.

Embodiment 1.

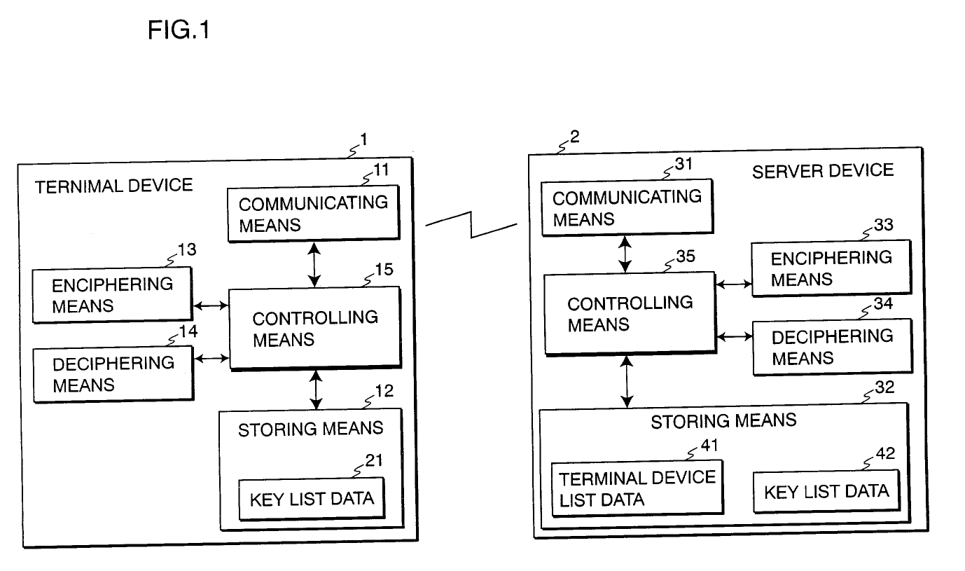

FIG. 1 is a block diagram showing the configuration of an enciphered communication system according to the embodiment 1 of the present invention.

A terminal device 1 is a terminal device such as a mobile phone, a PDA (Personal Data Assistant), or a personal computer, for performing enciphered communication with a server device.

In the terminal device 1, a communicating means 11 performs data communication with the server device 2 by establishing a channel between the terminal device 1 and the server device 2.

A storing means 12 is, for example, a nonvolatile memory for storing, as key list data, plural pieces of cipher key data allocated to itself in association with key identifiers inherent in respective pieces of cipher key data.

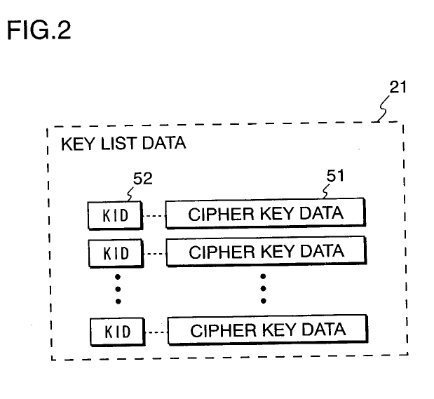

FIG. 2 is a block diagram showing the details of key list data 21 of the terminal device 1 in FIG. 1. As shown in FIG. 2, the storing means 12 stores respective pieces of cipher key data 51, and their inherent key identifiers(KID) 52 associated with the respective pieces of cipher key data 51.

Returning to FIG. 1, in the terminal device 1, an enciphering means 13 enciphers data based on any cipher key data 51 in the key list data 21.

A deciphering means 14 deciphers enciphered data based on any cipher key data 51 in the key list data 21.

A controlling means 15 controls ordinary (plain text) data communication and enciphered communication with the server device 2, and controls respective sections in the terminal device 1.

The server device 2 is a device capable of performing enciphered communication with a plurality of terminal devices 1 respectively. Incidentally, the terminal device 1 and the server device 2 are connected by a wireless or wired predetermined transmission path.

In the server device 2, a communicating means 31 performs data communication with the terminal device 1 by establishing a channel between the terminal device 1 and the server device 2.

A storing means 32 is a storing means such as a memory or a hard disk device for storing terminal device list data 41 including information on the respective terminal devices 1 (or their users), and key list data 42 including plural pieces of cipher key data allocated to the respective terminal devices 1 and key identifiers inherent in the respective pieces of cipher key data.

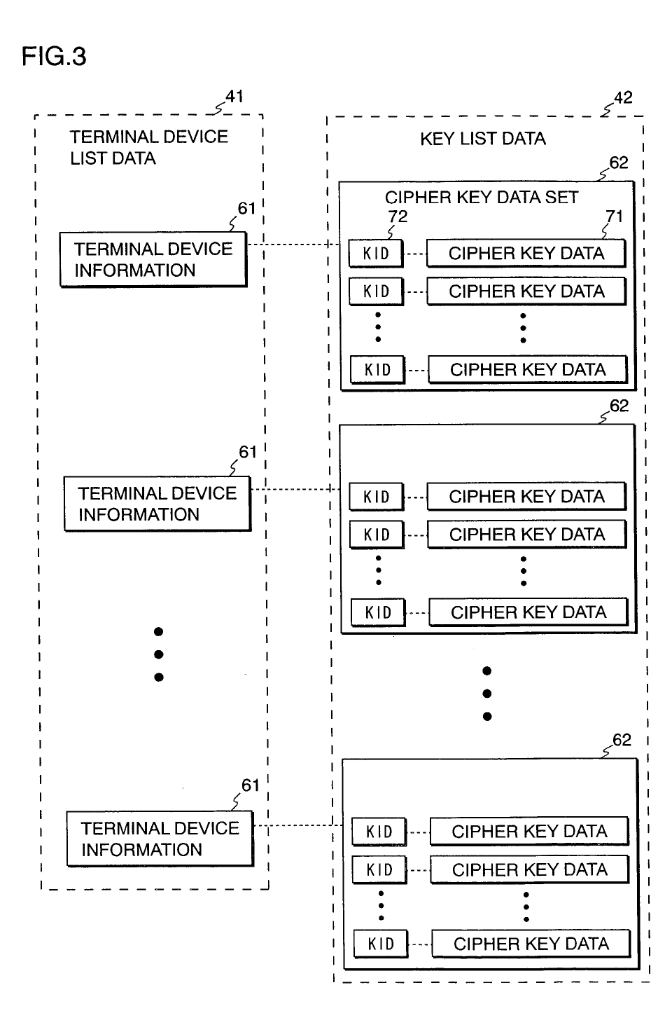

FIG. 3 is a block diagram showing the details of the terminal device list data 41 and the key list data 42 in the server device 2 in FIG. 1. As shown in FIG. 3, the terminal device list data 41 has terminal device information 61 including various identifiers regarding one or more terminal devices 1 registered in advance, and the key list data 42 has cipher key data sets 62 including cipher key data 71 and its key identifiers 72 allocated to the respective terminal devices 1 in association with the respective pieces of terminal device information 61.

Incidentally, the respective cipher key data sets 62 need not have the same number of pieces of cipher key data. Moreover, the cipher key data 71 (51) need not have the same bit length.

Namely, plural pieces of cipher key data 51 possessed by the authorized terminal device 1 and plural pieces of cipher key data 71 in the cipher key data set corresponding to this terminal device 1 possessed by the server device 2 are the same.

Returning to FIG. 1, in the server device 2, an enciphering means 33 enciphers data based on any of the plural pieces of cipher key data 71 in the cipher key data set 62 corresponding to the terminal device 1 as a communication counterpart.

A deciphering means 34 deciphers data based on any of the plural pieces of the cipher key data 71 in the data key set 62 corresponding to the terminal device 1 as the communication counterpart.

A controlling means 35 controls ordinary (plain text) data communication and enciphered communication with the terminal device 1, and controls respective sections in the server device 2.

Incidentally, the communicating means 11 of the terminal device 1 is a key identifier receiving means for receiving the key identifier 72 from the server device 2 and an enciphered key identifier transmitting means for transmitting the key identifier 72 enciphered by the enciphering means 13 to the server device 2, in the enciphered communication system of this embodiment 1.

Moreover, the communicating means 31 of the server device 2 is a key identifier transmitting means for transmitting the key identifier 72 of the selected cipher key data to the terminal device 1 and an enciphered key identifier receiving means for receiving the enciphered key identifier 72 transmitted from the terminal device 1, in the enciphered communication system of this embodiment 1.

Further, the communicating means 31 of the server device 2 is a first communicating means for enciphered communication in the enciphered communication system of this embodiment 1, and the communicating means 11 of the terminal device 1 is a second communicating means for the enciphered communication in this enciphered communication system.

Furthermore, the storing means 32 of the server device 2 is a first storing means in the enciphered communication system of the embodiment 1, and the storing means 12 of the terminal device 1 is a second storing means in this enciphered communication system.

The controlling means 15 of the terminal device 1 is a key reading means for reading the cipher key data 51 associated with the received key identifier 72 from the storing means 12, in the enciphered communication system of this embodiment 1.

Moreover, the controlling means 35 of the server device 2 is a key selecting means for selecting any one of the plural pieces of cipher key data 71 allocated to the terminal device 1 as the communication counterpart and an authenticating means for comparing the key identifier 72 deciphered by the deciphering means 34 and the key identifier 72 of the cipher key data selected before and authenticating the terminal device 1 in accordance with a result of the comparison, in the enciphered communication system of this embodiment 1.

Next, operations of the respective devices in the aforementioned system will be explained. In other words, an embodiment of an enciphered communication method of the present invention will be explained.

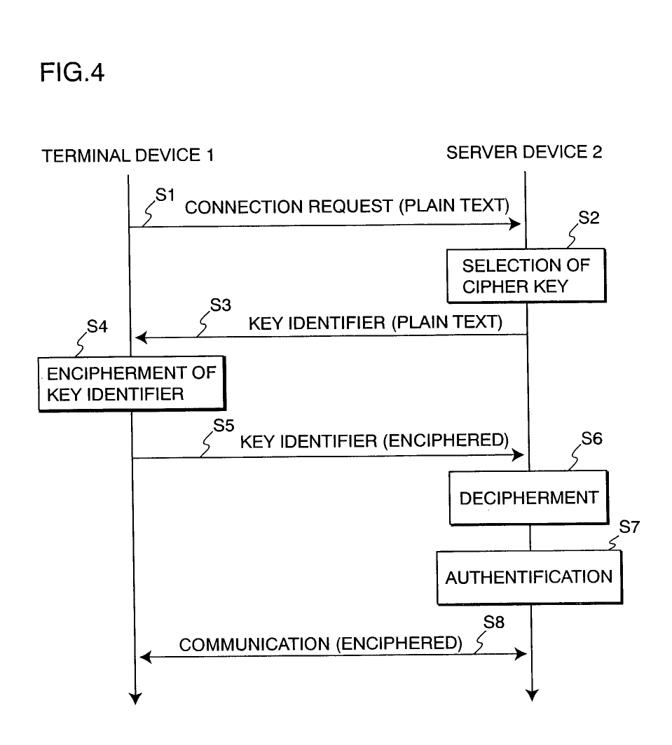

FIG. 4 is a sequence diagram explaining an enciphered communication method in the enciphered communication system according to the embodiment 1.

First, when the terminal device 1 accesses the server device 2, the controlling means 15 of the terminal device 1, in step S1, controls the communicating means 11 so that a connection request is transmitted to the server device 2.

When receiving this connection request via the communicating means 31, the controlling means 35 of the server device 2, in step 2, searches the terminal device list data 41 stored in the storing means 32, specifies the terminal device 1 as a requester of this connection request, and selects any one of the plural pieces of cipher key data 71 in the cipher key data set 62 corresponding to the terminal device 1.

On this occasion, the controlling means 35 determines the cipher key data 71 to be selected this time based on histories of the cipher key data 71 hitherto used, or determines the cipher key data 71 to be selected this time after generating irregularity based on a random number and the like.

In step S3, the controlling means 35 of the server device 2 reads the key identifier 72 of the selected cipher key data 71 and controls the communicating means 31 so that the key identifier 72 is transmitted in plain text as it is to the terminal device 1.

When receiving the key identifier 72 via the communicating means 11, the controlling means 15 of the terminal device 1 searches the key list data 21 stored in the storing means 21. Then, when finding the key identifier 52 identical with the key identifier 72 in the key list data 21, the controlling means 15 reads the cipher key data 51 corresponding to the key identifier 52.

Thereafter, in step S4, the controlling means 15 of the terminal device 1 supplies the read cipher key data 51 to the enciphering means 13 and controls the enciphering means 13 so that the received key identifier 72 is enciphered.

In step S5, the controlling means 15 of the terminal device 1 then controls the communicating means 11 so that the key identifier 72 enciphered by the enciphering means 13 is transmitted to the server device 2.

After reception of the enciphered key identifier 72 via the communicating means 31, the controlling means 35 of the server device 2, in step S6, controls the deciphering means 34 so that the enciphered key identifier 72 is deciphered based on the cipher key data 71 selected before (namely, the cipher key data 71 associated with the key identifier 72 transmitted to the terminal device 1).

Thereafter, in step S7, the controlling means 35 of the server device 2 receives the deciphered key identifier 72 from the deciphering means 34, and compares the key identifier 72 received from the terminal device 1 and deciphered and the key identifier 72 of the cipher key data selected before, and authenticates this terminal device 1 as the authenticated terminal device if both of the key identifiers 72 are identical.

After the terminal device 1 is authenticated as stated above, in step S8, in the terminal device 1 and the server device 2, encipherment and decipherment of data are performed by using the cipher key data 51 and 71 which are the same common key, and enciphered communication is carried out between the terminal device 1 and the server device 2.

In this case, data transmitted from the server device 2 to the terminal device 1 is enciphered by the enciphering means 33 of the server device 2 and deciphered by the deciphering means 14 of the terminal device 1. Similarly, data transmitted from the terminal device 1 to the server device 2 is enciphered by the enciphering means 13 of the terminal device 1 and deciphered by the deciphering means 34 of the server device 2.

Meanwhile, when the key identifier 72 transmitted from the terminal device 1 and deciphered and the key identifier 72 of the cipher key data 71 selected before are not identical, it is determined that this terminal device 1 does not have the cipher key data allocated to it, and this terminal device 1 is not authenticated.

For example, such an enciphered communication system as described above can be applied to a home banking system. In the home banking system, data communication is performed via a public line between customers and a bank, and hence the system needs not only confidentiality of communication data but also certain authentication of the customers via the public line on the bank side.

In this case, the bank installs the server device 2 and the customers who have their accounts at this bank possess the terminal devices 1. Regarding each of the customers, information on the terminal device 1 of the customer is registered as the terminal device information 61 on the terminal device list data 41 of the server device 2, and plural pieces of cipher key data 51 and 71 and the key identifiers 52 and 72 thereof are allocated to each customer.

When the customer uses the home banking system, the customer first operates the terminal device 1, and according to this operation, the terminal device 1 transmits a connection request to the server device 2 of the bank.

When searching the terminal device list data 41 and finding the terminal device information 61 on the terminal device 1 of this customer, the server device 2 selects any cipher key data 71 from the cipher key data set 62 corresponding to the terminal device information 61.

In the same manner as described above, the server device 2 transmits the key identifier 72 of the cipher key data 71 to the terminal device 1, and the terminal device 1 enciphers the key identifier 72 with the cipher key data 51 corresponding to the key identifier 52 identical with the key identifier 72 and transmits the enciphered key identifier 72 to the server device 2.

When receiving the enciphered key identifier 72, the server device 2 deciphers the key identifier 72 based on the cipher key data 71 selected before, compares the deciphered key identifier 72 and the key identifier 72 of the cipher key data 71 selected earlier (namely, stored in the storing means 32), when they are identical, authenticates the terminal device 1 of the customer, and starts enciphered communication.

In the aforementioned manner, the enciphered communication system of this embodiment 1 can be applied to the home banking system.

As described above, according to the aforementioned embodiment 1, the server device 2 selects a single piece of cipher key data 71 out of plural pieces of cipher key data 71 allocated to the terminal device 1 as the communication counterpart, and transmits the key identifier 72 of the selected cipher key data 71 to the terminal device 1. After receiving the key identifier 72, the terminal device 1 selects the cipher key data 51 corresponding to the key identifier 72 out of plural pieces of cipher key data 51 previously stored, enciphers the key identifier 72 based on the selected cipher key data 51, and transmits the enciphered key identifier 72 to the server device 2. The server device 2 deciphers the enciphered key identifier 72 based on the cipher key data 71 selected earlier, compares the deciphered key identifier 72 and the key identifier 72 of the cipher key data selected earlier, and authenticates the terminal device 1 in accordance with a result of the comparison. Thus, authentication processing in enciphered communication can be performed by using cipher key data and key identifiers in the enciphered communication system, whereby a circuit scale for authentication can be reduced.

Embodiment 2.

An enciphered communication system according to the embodiment 2 of the present invention is designed in such a manner that, in the enciphered system according to the aforementioned embodiment 1, the server device 2 can change the cipher key data stored in the terminal device 1.

It should be noted that the configuration of the enciphered communication system according to the embodiment 2 is the same as that of the enciphered communication system according to the embodiment 1 except that functions mentioned later are added to respective sections, and hence the explanation thereof is omitted.

The communicating means 11 of the terminal device 1, however, is a first receiving means for receiving a key identifier of cipher key data used for enciphering new cipher key data and a second receiving means for receiving the enciphered new cipher key data from the server device 2, in the enciphered communication system of this embodiment 2.

Further, the controlling means 15 of the terminal device 1 is a second updating means for updating cipher key data stored in the storing means 12 with the new cipher key data deciphered by the deciphering means 34, in the enciphered communication system of this embodiment 2.

Furthermore, the communicating means 31 of the server device 2 is a first transmitting means for transmitting the key identifier of the cipher key data used for enciphering the new cipher key data to the terminal device 1, and a second transmitting means for transmitting the new cipher key enciphered by the enciphering means 33 to the terminal device 1, in the enciphered communication system of this embodiment 2.

Moreover, the controlling means 35 of the server device 2 is a first updating means for updating the cipher key data stored in the storing means 32 with the new cipher key data, in the enciphered communication system of this embodiment 2.

Incidentally, the communicating means 11 of the terminal device 1 is an update completion identifier transmitting means for transmitting an identifier for confirming the completion of update which is enciphered by the enciphering means 13 to the server device 2, in the enciphered communication system of this embodiment 2.

Further, the communicating means 31 of the server device 2 is an update completion identifier receiving means for receiving the enciphered identifier for confirming the completion of update from the terminal device 1, in the enciphered communication system of this embodiment 2.

Furthermore, the controlling means 35 of the server device 2 is an update completion confirming means for determining whether or not the update of the cipher key with the new cipher key data has been completed by comparing the identifier for confirming the completion of update which is deciphered by the deciphering means 34, and the original identifier for confirming the completion of update, in the enciphered communication system of this embodiment 2.

Next, operations of the respective devices in the enciphered communication system according to the embodiment 2 will be explained. In other words, an embodiment of a key updating method of the present invention will be explained.

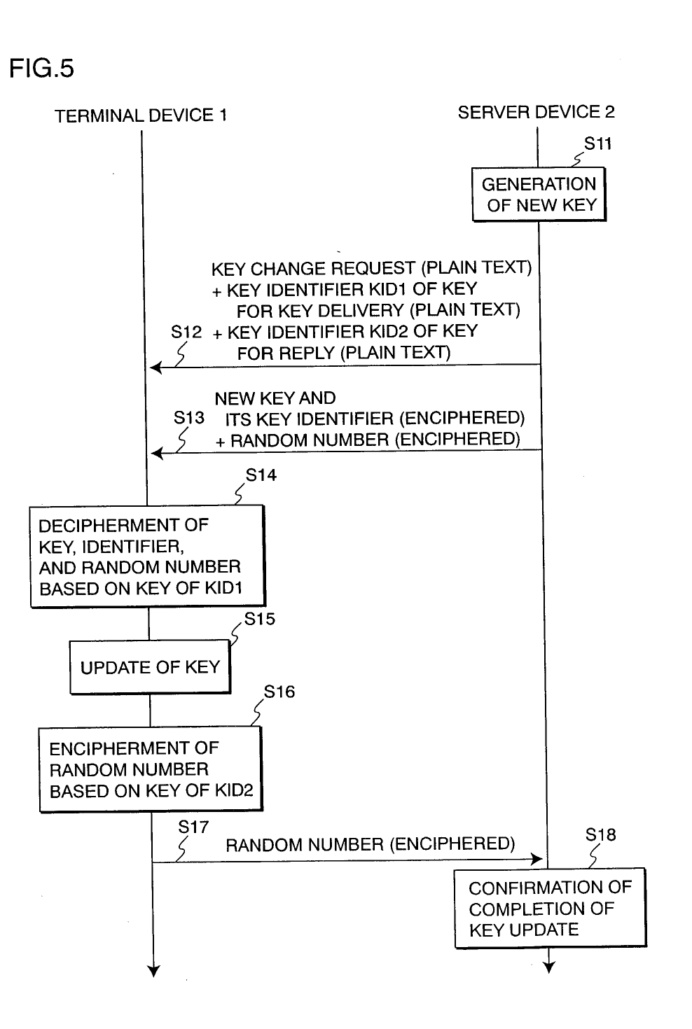

FIG. 5 is a sequence diagram explaining operations of the respective devices in key update in the enciphered communication system according to the embodiment 2.

In the case where the cipher key data 51 stored in a certain terminal device 1 is updated, first in step S11, the controlling means 35 of the server device 2 generates new cipher key data.

The controlling means 35 then updates the cipher key data 71 to be changed in the key list data 42 of the storing means 32 with the generated new cipher key data.

Subsequently, the controlling means 35 of the server device 2 selects any of the cipher key data 71 in the cipher key data set 62 corresponding to the terminal device 1, and controls the enciphering means 33 so that the new cipher key data is enciphered based on the cipher key data 71.

On this occasion, the controlling means 35 of the server device 2 generates a random number as an identifier for confirming the completion of update of the cipher key data 51 in the terminal device 1, and enciphers the random number.

Incidentally, in the cipher key data set 62, cipher key data 71 with different bit lengths may be registered, and the cipher key data 71 with a long bit length may be selected as the cipher key data to be used for enciphering the new cipher key data.

If a difference in bit length between the cipher key data is about twice, confidentiality of the new cipher key data can be ensured without enciphering processing and deciphering processing being increased greatly. The longer the bit length, the more preferable confidentiality becomes.

Moreover, when the new cipher key data is enciphered, the controlling means 35 of the server device 2, in step S12, controls the communicating means 31 and makes the communicating means 31 transmit to the terminal device 1 a key change request including the key identifier 52 of the cipher key data 51 to be changed together with a key identifier KID1 of the cipher key data 71 used for enciphering the new cipher key data and a key identifier KID2 for reply designating the cipher key data 51 to be used for enciphering the identifier for confirming the completion of update.

Furthermore, the controlling means 35 of the server device 2, in step S13, controls the communicating means 31 so that the enciphered new cipher key data and the enciphered random number for confirming the completion of update are transmitted to the terminal device 1.

When receiving the key change request and the two key identifiers KID1 and KID2, and the enciphered new cipher key data and the enciphered random number for confirming the completion of update, then the controlling means 15 of the terminal device 1, in step S14, controls the deciphering means 13 so that the enciphered new cipher key data and the enciphered random number for confirming the completion of update are deciphered based on the key identifier KID1.

Thereafter, in step S15, the controlling means 15 of the terminal device 1 specifies the cipher key data 51 designated by the key identifier 52 included in the key change request, and updates the cipher key data 51 with the deciphered new cipher key data.

After the completion of update of the cipher key data 51, the controlling means 15 of the terminal device 1, in step S16, reads the cipher key data 51 corresponding to the key identifier KID2 designated by the server device 2, and controls the enciphering means 13 so that the random number for confirming the completion of update deciphered in step S13 is enciphered based on the cipher key data 51.

Moreover, the controlling means 15 of the terminal device 1, in step S17, controls the communicating means 11 so that the enciphered random number for confirming the completion of update is transmitted to the server device 2.

When receiving the enciphered random number for confirming the completion of update via the communicating means 31, the controlling means 35 of the server device 2 supplies the key identifier selected before as the key identifier KID2 to the deciphering means 34 so that the enciphered random number for confirming the completion of update is deciphered.

Subsequently, the controlling means 35 of the server device 2, in step S17, compares the deciphered random number for confirming the completion of update and the original random number for confirming the completion of update, and when they are identical, it determines that the update of the cipher key data 51 in the terminal device 1 is completed. Incidentally, when they are not identical, the controlling means 35 of the server device 2 determines that the update of the cipher key data 51 in the terminal device 1 has not been completed.

It should be noted that, in the aforementioned operations, the update of the cipher key data 71 in the server device 2 may be performed after the completion of update of the cipher key data 51 of the terminal device 1 is confirmed.

Moreover, although the random number is used as the identifier for confirming the completion of update in the aforementioned embodiment 2, this random number can be generated sequentially by using a pseudo-random sequence. Also, other information or a number in other sequences may be used as the identifier for confirming the completion of update.

Furthermore, in the aforementioned embodiment 2, a channel for transmitting the key change request and so on and a channel for transmitting the new cipher key data and so on may be different. For example, when it is possible to establish a plurality of channels in a spread spectrum system transmission path between the terminal device 1 and the server device 2, it is suitable to use one channel as the channel for transmitting the key change request and so on and use another channel as the channel for transmitting the new cipher key data and so on. Consequently, in order to acquire cipher key data to be updated by eavesdropping, it is necessary to eavesdrop two channels in a spread spectrum system and break a cipher, and hence it becomes more difficult to look surreptitiously at the cipher key data to be updated.

Incidentally, other operations of the respective devices are the same as those according to the embodiment 1, and hence the explanation thereof is omitted.

As described above, according to the aforementioned embodiment 2, the server device 2 updates the cipher key data 71 with the new cipher key data, and the server device 2 enciphers the new cipher key data, transmits the enciphered new cipher key data to the terminal device 1, and further transmits the key identifier KID1 of the cipher key data 71 used for enciphering the new cipher key data to the terminal device 1. When receiving the key identifier KID1 of the cipher key data 71 used for enciphering the new cipher key data from the server device 2, the terminal device 1 selects the cipher key data 51 associated with the received key identifier KID1 out of the plural pieces of cipher key data 51 allocated to this terminal device 1, and when receiving the enciphered new cipher key data from the server device 2, it deciphers the enciphered new cipher key data based on the cipher key data 51 selected by the received key identifier KID1. The terminal device 1 then updates the stored cipher key data 51 with the deciphered new cipher key data. Consequently, the cipher key data can be changed to a new one while the confidentiality of the common key is ensured.

Moreover, according to the aforementioned embodiment 2, the server device 2 enciphers the new cipher key data and a random number for confirming the completion of update, and transmits the enciphered random number for confirming the completion of update therewith to the terminal device 1. The terminal device 1 receives the new cipher key data and the enciphered random number for confirming the completion of update from the server device 2, and deciphers the received enciphered random number for confirming the completion of update. When the update of the cipher key data is completed, the terminal device 1 enciphers the random number for confirming the completion of update, and transmits the enciphered random number for confirming the completion of update to the server device 2. The server device 2 receives and deciphers the enciphered random number for confirming the completion of update transmitted from the terminal device 1, and determines whether or not the update of the cipher key data with the new cipher key data has been completed by comparing the deciphered random number for confirming the completion of update and the original random number for confirming the completion of update. Consequently, it is difficult to forge the enciphered random number for confirming the completion of update, whereby the server device 2 can certainly confirm that the update of the cipher key data 51 of the terminal device 1 has been completed.

Further, according to the aforementioned embodiment 2, the server device 2 transmits the key identifier KID2 for reply designating the cipher key data 51 used when the random number for confirming the completion of update is enciphered in the terminal device 1, and the terminal device 1 receives the key identifier KID2 for replay. The terminal device 1 enciphers the deciphered random number for confirming the completion of update based on the cipher key data 51 associated with the key identifier KID2 for reply. On the other hand, the server device 2 deciphers the enciphered random number for confirming the completion of update received from the terminal device 1 based on the key identifier KID2 for reply. Thereby, the cipher key data 51 for enciphering the random number for confirming the completion of update is designated by the server device 2, and hence the cipher key data 51 for enciphering the random number for confirming the completion of update can be changed properly, whereby it becomes more difficult to forge the enciphered random number for confirming the completion of update.

Furthermore, according to the aforementioned embodiment 2, the server device 2 selects the cipher key data 71 having a longer bit length than the cipher key data 71 used in enciphered communication as the cipher key data 71 for enciphering the new cipher key data. Consequently, the cipher key data which requires higher confidentiality than ordinary communication data can be transmitted safely to the terminal device 1.

Incidentally, although, in the enciphered communication system of the aforementioned embodiment 2, the key updating method of the present invention is applied to the enciphered communication system of the embodiment 1, the present invention can be applied also to other enciphered communication systems having plural pieces of cipher key data common to a server device and a terminal device.

Embodiment 3.

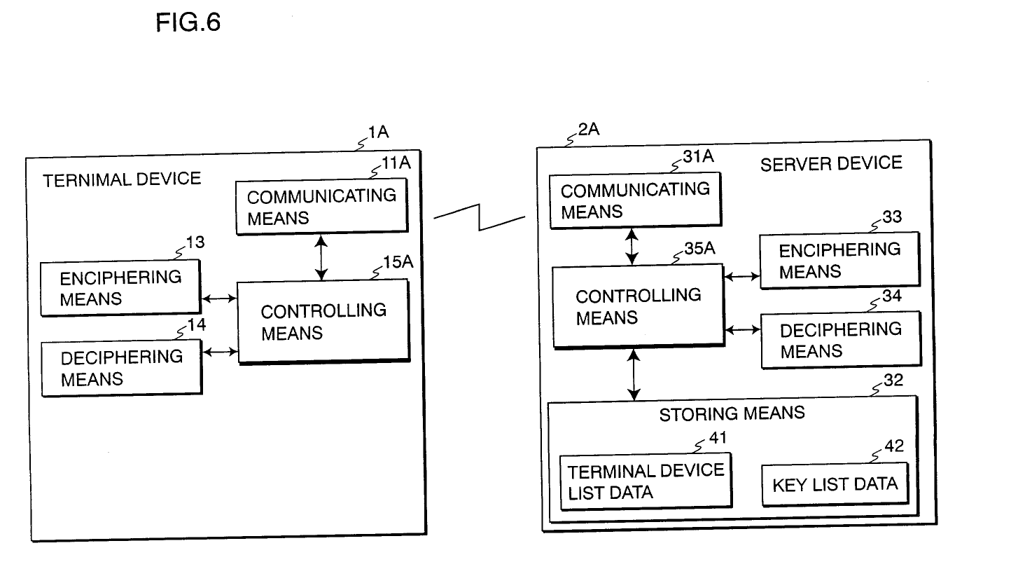

FIG. 6 is a block diagram showing the configuration of an enciphered communication system according to the embodiment 3 of the present invention. It should be noted that in FIG. 6, the same numerals and symbols are given to the same components as those in FIG. 1, and the explanation thereof is omitted.

A terminal device 1A is a terminal device such as a mobile phone, a PDA (Personal Data Assistant), or a personal computer, for performing data communication with a server device 2A by a spread spectrum system. For example, the terminal device 1A is obtained by adding the following functions to a mobile phone in which a CDMA (Code Divided Multiple Access) system is used as a multiple access method.

In the terminal device 1A, a communicating means 11A is a communicating means capable of establishing a plurality of channels by the spread spectrum system between the terminal device 1A and the server device 2A. Incidentally, among devices capable of such a communication system is a cellular phone proposed in a communication standard IMT-2000 (International Mobile Telecommunication-2000) or the like.

The controlling means 15A controls ordinary (plain text) data communication and enciphered communication with the server device 2A, and controls respective sections in the terminal device 1A.

The server device 2A is a device for performing data communication with respective terminal devices 1A by the spread spectrum system.

In the server device 2A, a communicating means 31A is a communicating means capable of establishing a plurality of channels by the spread spectrum system between the server device 2A and the terminal device 1A.

A controlling means 35A controls ordinary (plain text) data communication and enciphered communication with the terminal device 1A, and controls respective sections in the server device 2A.

Incidentally, the communicating means 31A of the server device 2A is a first communicating means in this enciphered communication system, and the communicating means 11A of the terminal device 1A is a second communicating means in this enciphered communication system.

Further, the communicating means 31A of the server device 2A is a cipher key transmitting means for transmitting cipher key data to the terminal device 1A, and the communicating means 11A of the terminal device 1A is a cipher key receiving means for receiving the cipher key data from the server device 2A.

Furthermore, the controlling means 35A of the server device 2A is a first key changing means in this enciphered communication system, and the controlling means 15A of the terminal device 1A is a second key changing means in this enciphered communication system.

Next, operations of the respective devices in the enciphered communication system according to the aforementioned embodiment 3 will be explained. In other words, an embodiment of an enciphered communication method according to the present invention will be explained.

First, the communicating means 11A of the terminal device 1A and the communicating means 31A of the server device 2A establish a first channel in a spread spectrum system transmission path between them.

Moreover, the communicating means 11A of the terminal device 1A and the communicating means 31A of the server device 2A establish second channel in the spread spectrum system transmission path.

The controlling means 35A of the server device 2A then selects any cipher key data 71 from the cipher key data set 62 corresponding to the terminal device 1A, and transmits the cipher key data 71 in plain text as it is to the terminal device 1A via the second channel in the spread spectrum system transmission path.

When receiving the cipher key data 71, the controlling means 15A of the terminal device 1A starts enciphered communication via the first channel in the spread spectrum system transmission path using the cipher key data 71.

At this time, likewise, the controlling means 35A of the server device 2A starts enciphered communication via the first channel in the spread spectrum system transmission path based on the cipher key data 71.

On the occasion of enciphered communication, data transmitted from the server device 2A to the terminal device 1A is enciphered by the enciphering means 33 of the server device 2A and deciphered by the deciphering means 14 of the terminal device 1A. Similarly, data transmitted from the terminal device 1A to the server device 2A is enciphered by the enciphering means 13 of the terminal device 1A and deciphered by the deciphering means 34 of the server device 2A.

Thus, enciphered communication is started between the terminal device 1A and the server device 2A.

Incidentally, each time the terminal device 1A accesses the server device 2A, that is, in each session, the server device 2A may transmit a different key to the terminal device 1A.

Even while enciphered communication is performed, that is, even during a session, it is possible to change the cipher key data 71 being used in this session. In this case, the controlling means 35 of the server device 2A first selects the new cipher key data 71 from the cipher key data set 62 corresponding to the terminal device 1A, and controls the transmitting means 31A so that the new cipher key data 71 is transmitted via the second channel different from the first channel being used in the session in the spread spectrum system transmission path.

Thereafter, the controlling means 35A of the server device 2A changes the cipher key data 71 used with respect to the terminal device 1A by the enciphering means 33 and the deciphering means 34 to the new cipher key data 71.

Meanwhile, when receiving the new cipher key data 71, the controlling means 15A of the terminal device 1A changes the cipher key data 71 used by the enciphering means 13 and the deciphering means 14 to the new cipher key data 71.

Incidentally, when there is a lag between the timing in which the cipher key data 71 is changed to the new cipher key data 71 in the terminal device 1A and the timing in which the cipher key data 71 is changed to the new cipher key data 71 in the server device 2A, it is recommended that information that the cipher key data 71 is updated be inserted into data transmitted from both the devices so that data after the detection of the information is deciphered by the new cipher key data 71. Alternatively, it is recommended that information showing a position at which the cipher key data 71 is changed in transmit data is transmitted and received between both the devices via a channel through which the cipher key data 71 is transmitted so that data after the position shown by the information is deciphered by the new cipher key data 71.

Moreover, in the aforementioned embodiment 3, the cipher key data 71 is transmitted in plain text as it is to the terminal device 1A via the second channel in the spread spectrum system transmission path, but in changing the cipher key data 71, it is also suitable to encipher the changed cipher key data 71 based on the cipher key data 71 before change by the enciphering means 33, transmit the enciphered changed cipher key data 71 to the terminal device 1A via the second channel in the spread spectrum system transmission path, decipher the changed cipher key data 71 by the deciphering means 14 in the terminal device 1A, and thereafter change the cipher key data 71. Thereby, the new cipher key data 71 as-enciphered is transmitted, and hence eavesdropping of enciphered communication becomes more difficult.

As described above, according to the aforementioned embodiment 3, enciphered communication is performed via the first channel in the spread spectrum system transmission path between the server device 2A and the terminal device 1A, and the cipher key data 71 used for the first channel is transmitted from the server device 2A to the terminal device 1A via the second channel different from the first channel in the spread spectrum system transmission path. Accordingly, in order to eavesdrop enciphered communication, the cipher key data 71 used in the enciphered communication needs to be eavesdropped, and after all, two channels in a spread spectrum system which have high confidentiality need to be eavesdropped, whereby eavesdropping of enciphered communication becomes difficult.

Moreover, according to the aforementioned embodiment 3, in the terminal device 1A, a storing means for storing the plural pieces of cipher key data 71 allocated to the terminal device 1A becomes unnecessary, which enables a reduced device cost and a reduced device size.

Further, according to the aforementioned embodiment 3, the server device 2 changes the cipher key data 71 used in enciphered communication, whereby eavesdropping of enciphered communication becomes more difficult.

Furthermore, according to the aforementioned embodiment 3, during a session with the terminal device 1, the server device 2 changes the new cipher key data 71 used in the session, and hence eavesdropping of enciphered communication becomes still more difficult.

Incidentally, in order to simplify the explanation, in FIG. 1 and FIG. 6, communication between the terminal devices 1 and 1A and the server devices 2 and 2A is performed directly, but various transit points may be disposed between the terminal devices 1 and 1A and the server devices 2 and 2A. For example, when the terminal device is a mobile phone, there exist transit points of a mobile phone network not shown.

Industrial Availability

As described above, in the present invention, an enciphered communication system, an enciphered communication method, a server device, a terminal device, and a key updating method, capable of reducing a circuit scale while performing authentication processing in enciphered communication can be obtained.

Further, in the present invention, an enciphered communication system and a key updating method, capable of changing a cipher key to a new one while ensuring the confidentiality of a common key can be obtained.

Furthermore, in the present invention, an enciphered communication system, an enciphered communication method, a server device, and a terminal device, capable of easily sharing a cipher key while ensuring the confidentiality of the common key can be obtained without plural pieces of cipher key data allocated to itself being stored on the terminal device side.

1. An enciphered communication system for performing enciphered communication between a server device and a terminal device,
wherein the server device comprises:
a first storing means for storing plural pieces of cipher key data allocated to each terminal device in association with key identifiers inherent in respective pieces of cipher key data;
a key selecting means for selecting any one of the plural pieces of cipher key data allocated to the terminal device which is a communication counterpart;
a key identifier transmitting means for transmitting the key identifier of the cipher key data selected by said key selecting means to the terminal device;
an enciphered key identifier receiving means for receiving the enciphered key identifier transmitted from the terminal device;
a deciphering means for deciphering the enciphered key identifier received by said enciphered key identifier receiving means based on the cipher key data selected by said key selecting means;
an authenticating means for comparing the key identifier deciphered by said deciphering means and the key identifier of the cipher key data selected by said key selecting means and authenticating the terminal device in accordance with a result of the comparison; and
a first communicating means for performing enciphered communication based on the cipher key data selected by said key selecting means with the terminal device authenticated by said authenticating means, and
wherein the terminal device comprises:
a second storing means for storing plural pieces of cipher key data allocated to itself in association with key identifiers inherent in respective pieces of cipher key data;
a key identifier receiving means for receiving the key identifier from the server device;
a key reading means for reading cipher key data associated with the key identifier received by said key identifier receiving means from said second storing means;
an enciphering means for enciphering the key identifier based on the cipher key data associated with the key identifier from the server device;
an enciphered key identifier transmitting means for transmitting the key identifier enciphered by said enciphering means to the server device; and
a second communicating means for performing enciphered communication with the server device based on the cipher key data read by said key reading means.

2. An enciphered communication method, comprising the steps of:
selecting a single piece of cipher key data from plural pieces of cipher key data allocated to a terminal device as a communication counterpart, in a server device;
transmitting a key identifier of the selected cipher key data from the server device to the terminal device;
after reception of the key identifier by the terminal device, selecting cipher key data associated with the key identifier from plural pieces of cipher key data stored previously, in the terminal device;
enciphering the key identifier based on the cipher key data associated with the key identifier from the server device, in the terminal device;
transmitting the enciphered key identifier from the terminal device to the server device;
deciphering the enciphered key identifier based on the cipher key data selected before, in the server device;
comparing the deciphered key identifier and the key identifier of the cipher key data selected before and authenticating the terminal device in accordance with a result of the comparison; and
performing enciphered communication between the server device and the authenticated terminal device by performing encipherment and/or decipherment with the selected cipher key data.

3. A server device for performing enciphered communication with a terminal device, comprising:
a storing means for storing plural pieces of cipher key data allocated to each terminal device in association with key identifiers inherent in respective pieces of cipher key data;
a key selecting means for selecting any one of the plural pieces of cipher key data allocated to the terminal device which is a communication counterpart;
a key identifier transmitting means for transmitting the key identifier of the cipher key data selected by said key selecting means to the terminal device;
an enciphered key identifier receiving means for receiving the enciphered key identifier transmitted from the terminal device;
a deciphering means for deciphering the enciphered key identifier received by said enciphered key identifier receiving means based on the cipher key data selected by said key selecting means;
an authenticating means for comparing the key identifier deciphered by said deciphering means and the key identifier of the cipher key data selected by said key selecting means and authenticating the terminal device in accordance with a result of the comparison; and
a communicating means for performing enciphered communication based on the cipher key data selected by said key selecting means with the terminal device authenticated by said authenticating means.

4. A terminal device for performing enciphered communication with a server device, comprising:
a storing means for storing plural pieces of cipher key data allocated to itself in association with key identifiers inherent in respective pieces of cipher key data;
a key identifier receiving means for receiving the key identifier from the server device;
a key reading means for reading the cipher key data associated with the key identifier received by said key identifier receiving means from said storing means;
an enciphering means for enciphering the key identifier based on the cipher key data associated with the key identifier from the server device;
an enciphered key identifier transmitting means for transmitting the key identifier enciphered by said enciphering means to the server device; and
a communicating means for performing enciphered communication with the server device based on the cipher key data read by said key reading means.

5. An enciphered communication system for performing enciphered communication between a server device and a terminal device,
wherein the server device comprises:
a first storing means for storing plural pieces of cipher key data in association with key identifiers inherent in respective pieces of cipher key data;
an enciphering means for enciphering new cipher key data;
a first transmitting means for transmitting a key identifier of cipher key data used for enciphering the new cipher key data to the terminal device;
a second transmitting means for transmitting the new cipher key data enciphered by said enciphering means to the terminal device; and
a first updating means for updating the cipher key data stored in said first storing means with the new cipher key data,
wherein the terminal device comprises:
a second storing means for storing plural pieces of cipher key data allocated to itself in association with key identifiers inherent in respective pieces of cipher key data;
a first receiving means for receiving the key identifier of the cipher key data used for enciphering the new cipher key data from the server device;
a second receiving means for receiving the enciphered new cipher key data from the server device;
a key reading means for reading from said second storing means cipher key data being associated with the key identifier received by said first receiving means;
a deciphering means for deciphering the enciphered new cipher key data received by said second receiving means based on the cipher key data read by said key reading means; and
a second updating means for updating the cipher key data stored in said second storing means with the new cipher key data deciphered by said deciphering means.

6. The enciphered communication system according to claim 5,
wherein said enciphering means of the server device enciphers the new cipher key data and an identifier for confirming completion of update,
wherein said first transmitting means or said second transmitting means of the server device transmits the enciphered identifier for confirming the completion of update to the terminal device,
wherein said first receiving means or said second receiving means of the terminal device receives the enciphered new cipher key data and the enciphered identifier for confirming the completion of update from the server device,
wherein said deciphering means of the terminal device deciphers the enciphered new cipher key data and the enciphered identifier for confirming the completion of update,
wherein the terminal device further comprises: an enciphering means for enciphering the identifier for confirming the completion of update deciphered by said deciphering means when the update of the cipher key data by said second updating means is completed; and an update completion identifier transmitting means for transmitting the identifier for confirming the completion of update enciphered by said enciphering means to the server device, and
wherein the server device further comprises: an update completion identifier receiving means for receiving the enciphered identifier for confirming the completion of update from the terminal device; a deciphering means for deciphering the enciphered identifier for confirming the completion of update; and an update completion confirming means for determining whether or not the update of the cipher key with the new cipher key data has been completed by comparing the identifier for confirming the completion of update deciphered by said deciphering means and the original identifier for confirming the completion of update.

7. The enciphered communication system according to claim 6,
wherein said first transmitting means or said second transmitting means of the server device transmits a key identifier for reply which designates cipher key data used when the identifier for confirming the completion of update is enciphered in the terminal device,
wherein said first receiving means or said second receiving means of the terminal device receives the key identifier for reply,
wherein said enciphering means of the terminal device enciphers the identifier for confirming the completion of update deciphered by said deciphering means based on cipher key data associated with the key identifier for reply, and
wherein said deciphering means of the server device deciphers the enciphered identifier for confirming the completion of update received by said update completion identifier receiving means based on the key identifier for reply.

8. The enciphered communication system according to claim 5,
wherein said enciphering means of the server device selects the cipher key data having a bit length longer than the cipher key data used in the enciphered communication as cipher key data for enciphering the new cipher key data.

9. The enciphered communication system according to any one of claims 5 to 8,
wherein said first transmitting means and said second transmitting means respectively transmit data to said first receiving means and said second receiving means via different channels in a spread spectrum system transmission path.

10. A key updating method, comprising the steps of:
updating cipher key data stored previously with new cipher key data in a server device;
enciphering the new cipher key data in the server device;
transmitting the enciphered new cipher key data from the server device to the terminal device;
transmitting a key identifier of cipher key data used for enciphering the new cipher key data from the server device to the terminal device;
after reception of the key identifier of the cipher key data used for enciphering the new cipher key data from the server device, selecting cipher key data associated with the received key identifier out of plural pieces of cipher key data allocated to the terminal device, in the terminal device;
after reception of the enciphered new cipher key data from the server device, deciphering the enciphered new cipher key data based on the cipher key data selected by the received key identifier, in the terminal device; and
updating the cipher key data in the terminal device with the deciphered cipher key data.

11. An enciphered communication system for performing enciphered communication between a server device and a terminal device,
wherein the server device comprises:
a first communicating means for performing enciphered communication with the terminal device via a first channel in a spread spectrum system transmission path; and
a cipher key transmitting means for transmitting cipher key data used for the first channel to the terminal device via a second channel different from the first channel in the spread spectrum system transmission path,
wherein the terminal device comprises:
a cipher key receiving means for receiving the cipher key data transmitted from the terminal device via the second channel; and
a second communicating means for performing enciphered communication with the server device via the first channel based on the cipher key data received by said cipher key receiving means.

12. The enciphered communication system according to claim 11,
wherein the server device further comprises a first key changing means for changing the cipher key data to perform encipherment and decipherment with respect to the first channel,
wherein said cipher key data transmitting means of the server device transmits new cipher key data to be changed by said first key changing means to the terminal device,
wherein the terminal device further comprises a second key changing means for changing the cipher key data used for the first channel and
wherein, when the new cipher key data is received by said cipher key receiving means of the terminal device, said second key changing means changes the cipher key data used for first channel to the received cipher key data.

13. The enciphered communication system according to claim 12,
wherein the server device, during a session with the terminal device via the first channel, transmits the new cipher key data used in the session to the terminal device via the second channel.

14. The enciphered communication system according to claim 12 or claim 13,
wherein the server device further comprises an enciphering means for enciphering the new cipher key data based on cipher key data being used currently,
wherein said cipher key transmitting means of the server device transmits the new cipher key data enciphered by said enciphering means to the terminal device via the second channel,
wherein the terminal device further comprises a deciphering means for deciphering the enciphered new cipher key data,
wherein said cipher key receiving means of the terminal device receives the enciphered new cipher key data via the second channel,
wherein said deciphering means of the terminal device deciphers the received enciphered new cipher key data, and
wherein said second key updating means of the terminal device changes the cipher key data used for the first channel to the deciphered new cipher key data.

15. An enciphered communication method, comprising the steps of:
performing enciphered communication between a server device and a terminal device via a first channel in a spread spectrum system transmission path; and
transmitting cipher key data used for the first channel from the server device to the terminal device via a second channel different from the first channel in the spread spectrum system transmission path.

16. A server device for performing enciphered communication with a terminal device, comprising:
a communicating means for performing the enciphered communication with the terminal device via a first channel in a spread spectrum system transmission path; and
a cipher key transmitting means for transmitting cipher key data used for the first channel via a second channel different from the first channel in the spread spectrum system transmission path.

17. A terminal device for performing enciphered communication with a server device, comprising:
a cipher key receiving means for receiving cipher key data transmitted from the terminal device via a first channel in a spread spectrum system transmission path; and
a communicating means for performing the enciphered communication with the server device via a second channel in the spread spectrum system transmission path.
